(19) United States
(12) Patent Application Publication
(10) Pub. No.: US 2018/0201228 A1
(43) Pub. Date: Jul. 19, 2018

(54) WIPER DEVICE

(71) Applicant: ASMO CO., LTD., Shizuoka-ken (JP)

(72) Inventors: Hideki Shiratori, Hamamatsu-shi (JP); Noriyuki Suzuki, Kosai-shi (JP); Yuji Sakakibara, Kosai-shi (JP)

(21) Appl. No.: 15/741,617

(22) PCT Filed: Aug. 25, 2016
(86) PCT No.: PCT/JP2016/074787

§ 371 Date: Jan. 3, 2018

(30) Foreign Application Priority Data
Sep. 8, 2015 (JP) 2015-176873
Sep. 8, 2015 (JP) 2015-176874
Nov. 17, 2015 (JP) 2015-224981
Apr. 15, 2016 (JP) 2016-082347

(51) Int. Cl. B60S 1/24; F16H 21/40; B60S 1/08; B60S 1/28

(52) U.S. Cl. CPC B60S 1/24; B60S 1/28; B60S 1/08; F16H 21/40

(57) ABSTRACT

The wiper device includes a first pivot shaft, a first swing lever, a second pivot shaft, a second swing lever, a link rod, a crank arm, and a drive rod. The first swing lever extends from the first pivot shaft in a radial direction of the first pivot shaft. The second swing lever extends from the second pivot shaft in a radial direction of the second pivot shaft. The link rod has a first end connected to a tip part of the first swing lever and a second end connected to a tip part of the second swing lever. The crank arm extends from an output shaft of a motor in a radial direction of this output shaft. The drive rod has a first end connected to a tip part of the crank arm and a second end connected to an intermediate part of the link rod.

### TECHNICAL FIELD

The present invention relates to a wiper device.

### BACKGROUND ART

A known wiper device includes a first swing lever, which extends from a first pivot shaft in a direction orthogonal to the shaft, a second swing lever, which extends from a second pivot shaft in a direction orthogonal to the shaft, and a connecting rod, which includes one end connected to a distal end of the first swing lever and another end connected to a distal end of the second swing lever (for example, refer to patent document 1). Wipers fixed to the first and second pivot shafts synchronously perform wiping. In the wiper device, a crank arm is fixed to an output shaft of a motor, and the crank arm is connected by a drive rod to the second swing lever. Thus, power is transmitted from the output shaft to the second swing lever (second pivot shaft), and the connecting rod transmits the power to the first swing lever (first pivot shaft).

A further wiper device includes a ball joint that connects a drive force transmission rod (drive rod or connecting rod) to a swing lever (for example, refer to patent document 1). The ball joint includes a ball pin, which is fixed to the swing lever, and a joint case, which is fixed to the rod. The ball pin includes a basal end, which is inserted through and swaged to the swing lever, a shaft portion, which is arranged on the swing lever, and a spherical portion, which is arranged on the distal end of the shaft portion. The joint case includes a spherical recess (socket) that holds the spherical portion in a reliable manner.

Another example of a wiper device includes a motor, a connecting frame fixed to the motor, and pivot holders fixed to the two ends of the connecting frame. The pivot holders each include a holder portion, which holds a pivot shaft connected to a wiper, a holder vehicle body fixing portion, which extends from the holder and is fixed to the vehicle body, and a brittle portion, which is located between the holder portion and the holder vehicle body fixing portion (for example, refer to patent document 3). In such a wiper device, for example, when an object strikes the distal end of the pivot shaft (basal end of wiper) and external force (impact) is applied downward in the axial direction to the pivot shaft, the brittle portion breaks so that an integrated unit of the pivot shaft, the holder portion, the connecting frame, the motor, and the like moves downward (collapses). This reduces the impact (reaction from pivot shaft) applied to the object.

### PRIOR ART DOCUMENTS

### Patent Documents

Patent Document 1: Japanese Laid-Open Patent Publication No. 2008-207701

Patent Document 2: Japanese Patent No. 4142494

Patent Document 3: Japanese Laid-Open Patent Publication No. 2004-330895

### SUMMARY OF THE INVENTION

### Problems that are to be Solved by the Invention

In a wiper device such as that described in patent document 1, the connecting rod and the drive rod are connected to the distal end of the second swing lever. This enlarges the second swing lever (increases area of second swing lever as viewed in axial direction of second pivot shaft) and, for example, raises the material cost of the lever. Further, connection of the connecting rod to one surface of the second swing lever and the drive rod to the other surface of the second swing lever will also enlarge the second swing lever in the axial direction. This further increases the actuation space of the second swing lever and makes it difficult to obtain space in the vehicle for installation of the wiper device.

In a wiper device including a ball joint such as that described in patent document 2, the shaft portion of the ball pin is arranged on the swing lever extending in the thickness-wise direction. The plane of the swing lever is offset in the thickness-wise direction from the spherical portion that receives the drive force. Thus, when drive force is transmitted between the swing lever and the drive rod, force will be applied to the swing lever in a direction inclined relative to a direction orthogonal to the thickness-wise direction (i.e., direction extending along plane of swing lever). Thus, the swing lever needs to be thick and rigid so as not to be deformed by force acting in the inclined direction and applied by the shaft portion. This, for example, raises the material cost.

In a wiper device including a brittle portion such as that described in patent document 3, a large space is required in the vehicle to allow for downward movement of the large integrated unit including the pivot shaft, the holder portion, the connecting frame, the motor, and the like.

It is a first object of the present invention to provide a wiper device that allows the swing lever to be reduced in size.

It is a second object of the present invention to provide a wiper device that allows the swing lever to be reduced in thickness.

It is a third object of the present invention to provide a wiper device that reduces the impact applied to a striking object while allowing the swing lever to be reduced in thickness.

### Means for Solving the Problem

To achieve the first object, a wiper device according to a first aspect of the present invention includes a first pivot shaft, a first swing lever, a second pivot shaft, a second swing lever, a connecting rod, a crank arm, and a drive arm. The first swing lever extends from the first pivot shaft in a radial direction of the first pivot shaft and is pivoted integrally with the first pivot shaft. The second swing lever extends from the second pivot shaft in a radial direction of the second pivot shaft and is pivoted integrally with the second pivot shaft. The connecting rod includes a first end connected to a distal end of the first swing lever and a second end connected to a distal end of the second swing lever. The crank arm extends from an output shaft of a motor in a radial direction of the output shaft and is rotated integrally with the output shaft. The drive rod includes a first end connected to a distal end of the crank arm and a second end connected to a middle portion of the connecting rod.

To achieve the second object, a wiper device according to a second aspect of the present invention includes a pivot shaft, a swing lever, a connecting rod, and a ball joint. The swing lever extends from the pivot shaft in a direction orthogonal to an axial direction of the pivot shaft. The connecting rod transmits drive force to a distal end of the swing lever. The ball joint connects the distal end of the swing lever to the connecting rod. The ball joint includes a roll center located in a thickness range of the swing lever.

To achieve the third object, a wiper device according to a third aspect of the present invention includes a motor, a connecting frame to which the motor is fixed, and a pivot holder. The pivot holder includes a holder portion, a connecting frame fixing portion, and a holder vehicle body fixing portion. The holder portion holds a pivot shaft including an upper end connected to a wiper. The connecting frame fixing portion extends from the holder portion and is fixed to the connecting frame. The holder vehicle body fixing portion extends from the holder portion and fixed to the vehicle body. An extension between the holder portion and the connecting frame fixing portion includes a brittle portion.

### BRIEF DESCRIPTION OF THE DRAWINGS

FIG. 1 is a perspective view showing part of a vehicle according to a first embodiment of the present invention.

FIG. 2 is a schematic diagram entirely showing the wiper device of FIG. 1.

FIG. 3 is a partially cross-sectional view showing a first swing lever and a connecting rod of FIG. 2 in a connected state.

FIG. 4 is a partially cross-sectional view illustrating a ball joint of FIG. 3.

FIG. 5 is a schematic view illustrating where the connecting rod of FIG. 2 is located.

FIG. 6 is a partially cross-sectional view showing the first swing lever and the connecting rod in a connected state in a further example of the first embodiment.

FIG. 7 is a partially cross-sectional view showing the first swing lever and the connecting rod in a connected state in another example of the first embodiment.

FIG. 8 is a perspective view of a wiper device according to a second embodiment of the present invention.

FIG. 9 is a side view of the wiper device shown in FIG. 8.

FIG. 10A is a cross-sectional view taken along line A-A in FIG. 9, FIG. 10B is a cross-sectional view taken along line B-B in FIG. 9, and FIG. 10C is cross-sectional view taken along line C-C in FIG. 9.

FIG. 11 is a schematic view illustrating the operation of the wiper device shown in FIG. 9.

### EMBODIMENTS OF THE INVENTION

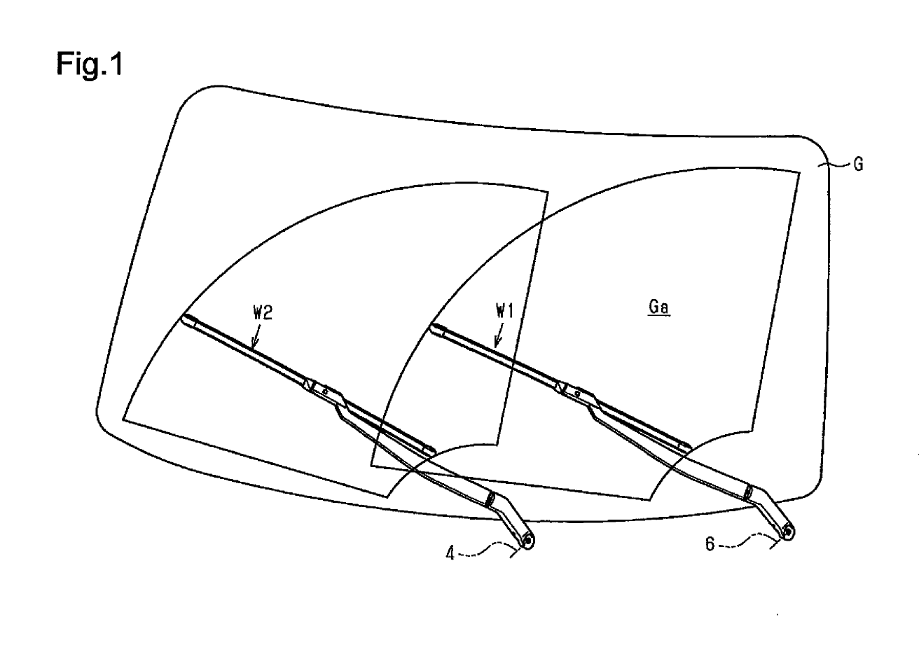

One embodiment of a wiper device will now be described with reference to FIGS. 1 to 5.

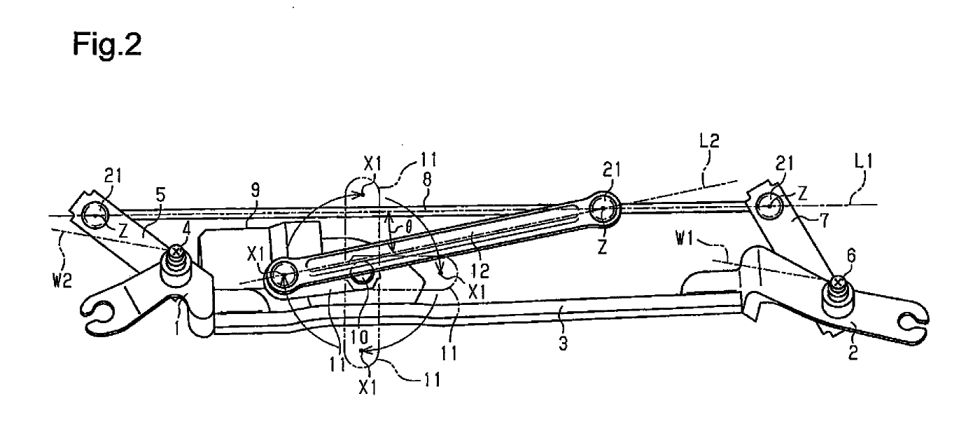

As shown in FIG. 1, a vehicle includes a windshield G and first and second wipers W1 and W2 that wipe a wiping surface Ga of the windshield G that is located outward with respect to the passenger compartment. The wiper device of FIGS. 1 and 2 is for a left-hand drive vehicle. The first wiper W1 wipes the driver seat side (right side as viewed in FIG. 1) of the wiping surface Ga, and the second wiper W2 wipes the passenger seat side (left side as viewed in FIG. 1) of the wiping surface Ga.

As shown in FIG. 2, the wiper device includes first and second pivot holders 1 and 2 and a connecting frame 3 that connects the first and second pivot holders 1 and 2. The wiper device is fixed to the body (not shown) located downward from the windshield G (refer to FIG. 1).

Further, the wiper device includes a first pivot shaft 4, which is rotationally supported by the first pivot holder 1, and a first swing lever 5, which extends from the lower end of the first pivot shaft 4 in the radial direction (direction orthogonal to axis) of the first pivot shaft 4 and pivots integrally with the first pivot shaft 4. The second wiper W2 is fixed to the upper end of the first pivot shaft 4.

The wiper device also includes a second pivot shaft 6, which is rotationally supported by the second pivot holder 2, and a second swing lever 7, which extends from the lower end of the second pivot shaft 6 in the radial direction (direction orthogonal to axis) of the second pivot shaft 6 and pivots integrally with the second pivot shaft 6. The first wiper W1 is fixed to the upper end of the second pivot shaft 6.

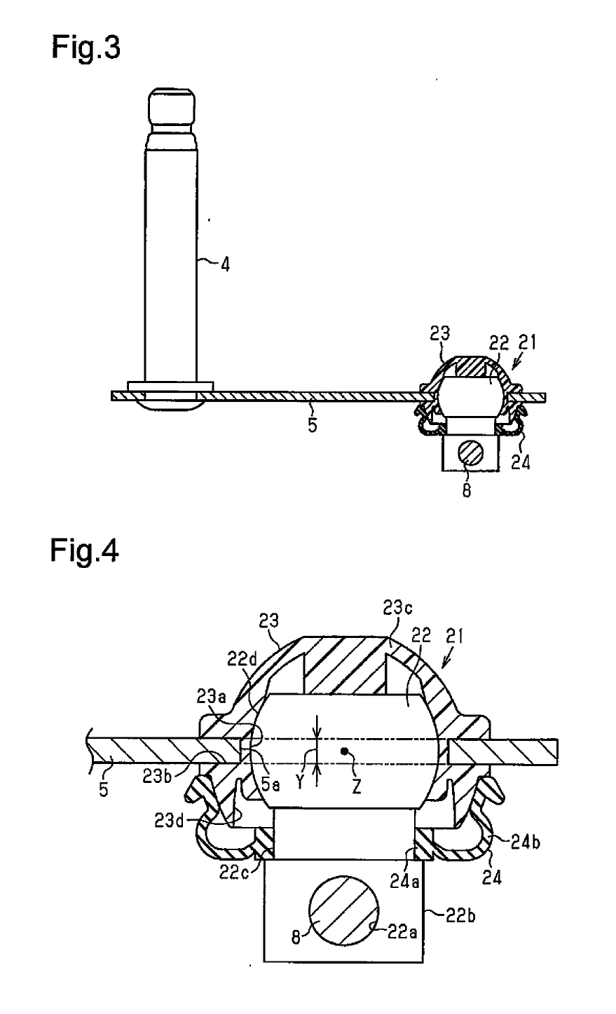

The wiper device includes a connecting rod 8 that has one end connected to the distal end of the first swing lever 5 and another end connected to the distal end of the second swing lever 7. As shown in FIGS. 3 to 5, the connecting rod 8 is formed by a solid (non-hollow) bar. In the present embodiment, the connecting rod 8 is formed by a metal bar having a circular cross-section.

The wiper device includes a motor 9, which is fixed to the connecting frame 3, and a crank arm 11, which extends in the radial direction (direction orthogonal to axis) from an output shaft 10 of the motor 9 and rotates integrally with the output shaft 10. In the present embodiment, the output shaft 10 of the motor 9 is located closer to the first pivot shaft 4 than the second pivot shaft 6.

The wiper device includes a drive rod 12 including one end connected to a distal end of the crank arm 11 and another end connected to a middle portion of the connecting rod 8. In the present embodiment, the drive rod 12 is connected to the connecting rod 8 at a position closer to the second swing lever 7 than the first swing lever 5. A straight line L1, which connects the connection point (roll center Z) of the first swing lever 5 and the connecting rod 8 and the connection point (roll center Z) of the second swing lever 7 and the connecting rod 8, and a straight line L2, which connects the connection point (roll center) of the crank arm 11 and the drive rod 12 and the connection point (roll center) of the connecting rod 8 and the drive rod 12, are set to be spaced apart by an angle θ that is acute. Preferably, the angle θ is set to be constantly in a range that is less than 45 degrees during movement of the crank arm 11. Further, during operation of the motor 9, or rotation of the crank arm 11, the crank arm 11 overlaps (traverses) the connecting rod 8 as viewed in the axial direction of the output shaft 10. In other words, as viewed in the axial direction of the output shaft 10, a connection point X1 of the crank arm 11 and the drive rod 12 is set to alternatively move during rotation of the crank arm 11 between a position located closer to the output shaft 10 than the connecting rod 8 (lower side of straight line L1 as viewed in FIG. 2) and a position opposite to the position located closer to the output shaft 10 than the connecting rod 8 (upper side of straight line L1 as viewed in FIG. 2).

The first swing lever 5, the second swing lever 7, and the drive rod 12 are all located at an upper side of the connecting rod 8 (distal side of first and second pivot shafts 4 and 6) and connected to the connecting rod 8.

In detail, the first swing lever 5, the second swing lever 7, and the drive rod 12 are each connected to the connecting rod 8 by a ball joint 21.

As shown in FIGS. 3 and 4, each ball joint 21 includes a ball pin 22 fixed to the connecting rod 8, a joint case 23 fixed to the first swing lever 5, and a dustproof-waterproof cover 24. The ball joints 21 are identical to one another. Thus, only the ball joint 21 that connects the first swing lever 5 and the connecting rod 8 will be described in detail, and the other ball joints 21 will not be described.

The ball pin 22 includes a fixing portion 22b, a shaft portion 22c, and a spherical portion 22d. The fixing portion 22b includes a fixing hole 22a. The connecting rod 8 is inserted through and fixed to the fixing hole 22a. The shaft portion 22c extends from the fixing portion 22b in a direction orthogonal to the direction in which the fixing hole 22a extends. The spherical portion 22d is arranged on the distal end of the shaft portion 22c. More specifically, the ball pin 22 extends from the connecting rod 8 in a direction orthogonal to the longitudinal direction of the connecting rod 8, and the distal portion of the ball pin 22 includes the spherical portion 22d. The ball pin 22 is arranged so that the connecting rod 8 is embedded in the ball pin 22. The spherical portion 22d is formed so that its outer surface has the shape of a sphere less the upper and lower parts.

The joint case 23 includes a spherical recess 23a that holds the spherical portion 22d in a rollable manner. The joint case 23 further includes a cap 23c and an opening 23d. The cap 23c is cap-shaped and covers the upper part of the spherical portion 22d. The first and second pivot shafts 4 and 6 extend from the first and second swing levers 5 and 7 toward a first side. The cap 23c is located at the first side of the first and second swing levers 5 and 7 and is shaped to cover portions of the corresponding one of the first and second swing levers 5 and 7 located at the first side. The opening 23d is located in the lower portion of the joint case 23. The opening 23d is located at a second side of the first and second swing levers 5 and 7 opposite to the first side. The outer portion of the joint case 23 includes an annular groove 23b fitted to the first swing lever 5 in a coupling hole 5a.

The dustproof-waterproof cover 24 includes a fixed annular portion 24a, which is fitted onto the shaft portion 22c, and a thin enveloping portion 24b, which closes a lower opening of the joint case 23. The enveloping portion 24b is flexible so as to elastically deform and follow the rolling of the ball joint 21 (in detail, sliding of spherical portion 22d in spherical recess 23a) to keep the lower opening of the joint case 23 closed.

The ball joint 21 of the present embodiment is located so that its roll center Z (i.e., center of spherical portion 22d) is located within a thickness range Y of the first swing lever 5 and at a center position in the range Y.

As shown in FIG. 2, the roll centers Z of all (three) ball joints 21 are located on a straight line. More specifically, the roll center Z of the ball joint 21 connecting the drive rod 12 and the connecting rod 8, the roll center Z of the ball joint 21 connecting the first swing lever 5 and the connecting rod 8, and the roll center Z of the ball joint 21 connecting the second swing lever 7 and the connecting rod 8 are located on the straight line L1.

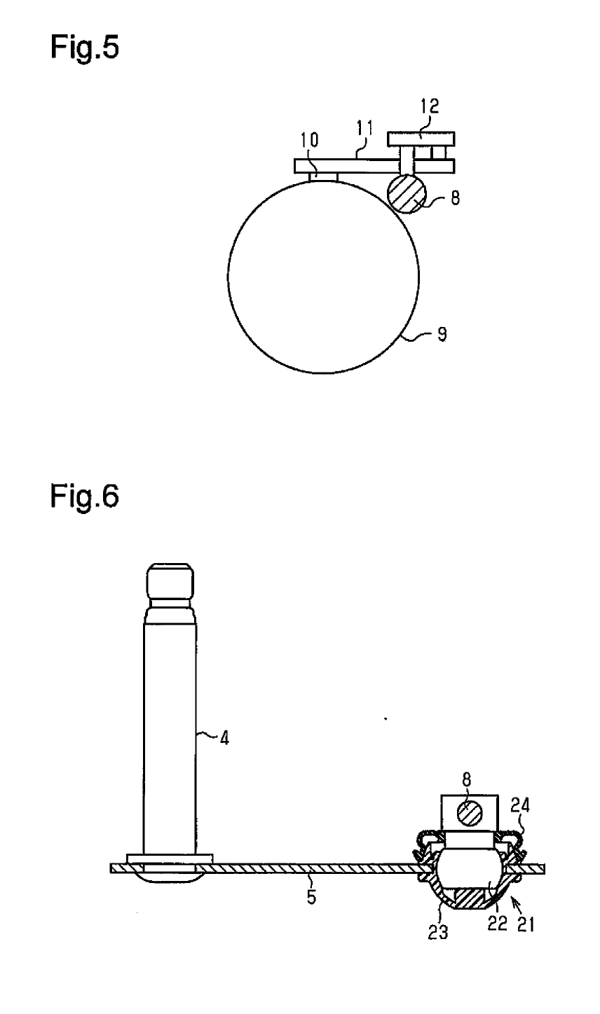

As schematically shown in FIG. 5, the connecting rod 8 is arranged to pass between the motor 9 and a movement area of the crank arm 11 (in gap extending in axial direction of output shaft 10). The phrase of “movement area of the crank arm 11” refers to the movement area occupied by the crank arm 11 when the crank arm 11 rotates about the axis of the output shaft 10. In detail, during operation of the motor 9, the connecting rod 8 of the present embodiment moves substantially in the longitudinal direction of the connecting rod 8 (direction orthogonal to plane of FIG. 5) and in a direction orthogonal to the output shaft 10 (lateral direction of FIG. 5). During movement of the connecting rod 8, as the connecting rod 8 becomes closest to at least the output shaft 10, at least a portion of the connecting rod 8 passes between the motor 9 and the movement area of the crank arm 11.

The operation of the wiper device in the first embodiment will now be described.

When, for example, a washer switch arranged near the driver seat is operated, drive current is supplied to the motor 9 to rotate and drive the output shaft 10 and the crank arm 11. This transmits power with the drive rod 12 and the connecting rod 8 to the first and second swing levers 5 and 7 in order to move the first and second swing levers 5 and 7 back and forth and pivot the first and second pivot shafts 4 and 6. Thus, the first and second wipers W1 and W2, which are fixed to the first and second pivot shafts 4 and 6, synchronously move back and forth to perform wiping.

The above embodiment has the advantages described below.

(1) The drive rod 12 includes one end connected to a distal end of the crank arm 11 and another end connected to the middle portion of the connecting rod 8, which connects the first swing lever 5 and the second swing lever 7. Thus, for example, compared to a structure in which the other end of the drive rod 12 is coupled to the distal end of the second swing lever 7, the second swing lever 7 can be reduced in size. More specifically, in a structure in which the connecting rod 8 and the drive rod 12 are each connected by the ball joint 21 to the distal end of the second swing lever 7, the second swing lever 7 needs to be increased in area to obtain space for the connection. In contrast, in the present embodiment, the drive rod 12 is not connected to the distal end of the second swing lever 7 (and only needs to be connected to connecting rod 8). This allows the second swing lever 7 to be reduced in size (reduce area of second pivot shaft 6 as viewed in axial direction). As a result, the material costs of the second swing lever 7 can be lowered. Further, for example, compared to a structure in which the other end of the drive rod 12 is connected to the distal end of the second swing lever 7, the length of the drive rod 12 can be decreased. Further, the first swing lever 5 and the second swing lever 7 are each provided with the single ball joint 21 (in detail, single joint case 23). Thus, the first swing lever 5 and the second swing lever 7 can be formed to have the same shape. In addition, in comparison with when the connecting rod 8 and the drive rod 12 are respectively coupled to one surface and the other surface of the second swing lever 7, the actuation space in the axial direction (vertical direction) of the second pivot shaft 6 can be reduced, and space for installation in the vehicle can be obtained.

(2) The first swing lever 5, the second swing lever 7, and the drive rod 12 are all located at the upper side of the connecting rod 8 (distal side of first and second pivot shafts 4 and 6) and connected to the connecting rod 8. This allows the wiper device to be reduced in thickness (dimension) in the vertical direction. More specifically, in a structure in which one of the first swing lever 5, the second swing lever 7, and the drive rod 12 is arranged at the opposite side of the connecting rod 8 in the vertical direction and connected to the connecting rod 8, the additional thickness in the vertical direction of the member arranged at the opposite side increases the thickness (dimension) in the vertical direction of the wiper device.

However, such a situation can be avoided, and the thickness in the vertical direction (dimension) can be reduced.

(3) The first swing lever 5, the second swing lever 7, and the drive rod 12 are each connected to the connecting rod 8 by the corresponding ball joint 21. Further, the roll center Z of every one of the ball joints 21 is located on a straight line (L1). Thus, when driven, a twisting movement does not occur. This allows for satisfactory movement. For example, if the first swing lever 5 and the second swing lever 7 are connected to one side of the connecting rod 8 in the vertical direction and the drive rod 12 is connected to the other side of the connecting rod 8 in the vertical direction, the swinging propulsion from the drive rod 12 will swing the connecting rod 8 about the straight line L1 connecting the connection point (roll center Z) of the connecting rod 8 and the first swing lever 5 and the connection point (roll center Z) of the connecting rod 8 and the second swing lever 7. The structure described above prevents or reduces such swinging.

(4) The output shaft 10 of the motor 9 is located at a position closer to the first pivot shaft 4 than the second pivot shaft 6, and the drive rod 12 is connected to the connecting rod 8 at a position closer to the second swing lever 7 than the first swing lever 5. Thus, the motor 9, the drive rod 12, and the like can be arranged in a satisfactory manner between the first pivot shaft 4 and the second pivot shaft 6 (in widthwise direction of vehicle). Further, the angle θ is acute between the straight line L1, which connects the connection points (roll centers Z) of the first and second swing levers 5 and 7 with the connecting rod 8, and the straight line L2, which connects the connection points (roll centers) of the crank arm 11 and the connecting rod 8 with the drive rod 12. Preferably, the angle θ is set to be constantly within a range of 45 degrees or less during actuation of the crank arm 11. Thus, the swing propulsion from the drive rod 12 can be efficiently transmitted along the connecting rod 8.

(5) During operation of the motor 9, that is, during rotation of the crank arm 11, the crank arm 11 overlaps the connecting rod 8 (traverses connecting rod 8) as viewed in the axial direction of the output shaft 10. Thus, for example, in comparison with a structure in which the crank arm 11 does not overlaps the connecting rod 8 during operation of the motor 9, the actuation space (i.e., installation space in vehicle) can be reduced as viewed in the axial direction of the output shaft 10.

(6) During operation of the motor 9, the connecting rod 8 passes between the motor 9 and the movement area of the crank arm 11 (in axial direction of output shaft 10). Thus, for example, in comparison with a structure in which the connecting rod 8 does not pass between the motor 9 and the crank arm 11, the actuation space as viewed in the axial direction of the output shaft 10 (i.e., installation space of vehicle) can be reduced.

(7) The connecting rod 8 is formed by a solid (non-hollow) bar. Thus, in comparison with when formed from a non-solid (hollow) pipe material, the rigidity can be increased with a smaller diameter. For example, in the wiper device of the present embodiment in which the connecting rod 8 passes between the motor 9 and the crank arm 11, the distance between the motor 9 and the crank arm 11 can be further decreased compared to when the connecting rod is formed from a pipe material. This allows the wiper device to be reduced in size in the axial direction (vertical direction) of the output shaft 10.

(8) During rotation of the crank arm 11, the connection point of the crank arm 11 and the drive rod 12 as viewed in the axial direction of the output shaft 10 alternately moves between a position closer to the output shaft 10 than the connecting rod 8 and a position located at the opposite side of the position closer to the output shaft 10 than the connecting rod 8. Thus, for example, in comparison with a structure that does not produce such an alternative movement, the actuation space can be reduced as viewed in the axial direction of the output shaft 10. More specifically, there is no need to lay out each element so that the connecting rod 8 is constantly located outside the movement area of the crank arm 11 when the crank arm 11 pivots in order to avoid interference of the connecting rod 8 with the crank arm 11.

(9) The ball joints 21 are each arranged so that their roll centers Z are arranged in the thickness range Y of the first and second swing levers 5 and 7. Thus, when drive force is transmitted between each of the first and second swing levers 5 and 7 and the connecting rod 8, the application of force can be prevented or reduced in a direction inclined relative to a direction orthogonal to the thickness-wise direction of the first and second swing levers 5 and 7. This limits the application of force that deforms the first and second swing levers 5 and 7 and allows the first and second swing levers 5 and 7 to be thin while obtaining rigidity. As a result, for example, the material costs of the first and second swing levers 5 and 7 can be reduced. Further, this prevents the application of force that acts to incline the first and second swing levers 5 and 7 and the first and second pivot shafts 4 and 6, which rotate integrally with the first and second swing levers 5 and 7.

In the wiper device of the prior art, when swaging and fixing the shaft portion of the ball pin to the corresponding one of the first and second swing levers, there is a need to slightly incline the shaft portion relative to a direction orthogonal to the first and second swing levers. For such a reason, the distance varies between the axis of each of the first and second pivot shafts 4 and 6 and the corresponding roll center Z. This increases differences in the swing angle range of the first and swing levers and, consequently, easily produces differences in the swing angle range of the wipers. The present invention avoids differences in the swing angle range of the wipers that would be caused by such a reason.

(10) The ball joint 21 is arranged so that its roll center Z is located at the center position in the thickness range Y of the corresponding one of the first and second swing levers 5 and 7. This further limits the force applied to the first and second swing levers 5 and 7 acting to deform the first and second swing levers 5 and 7 and consequently allows the first and second swing levers 5 and 7 to be reduced in thickness.

(11) The ball joint 21 includes the ball pin 22, which is arranged on the connecting rod 8, and the joint case 23, which is arranged on the corresponding one of the first and second swing levers 5 and 7. The ball pin 22 includes the spherical portion 22d and a portion embedded in the connecting rod 8. The spherical portion 22d is accommodated in the joint case 23 in a rollable manner. The first and second pivot shafts 4 and 6 extend from the first and second swing levers 5 and 7 toward the first side. The joint case 23 includes the cap 23c and the opening 23d. The cap 23c is located at the first side of the first and second swing levers 5 and 7 and is cap-shaped to cover portions of the corresponding one of the first and second swing levers 5 and 7 located at the first side. The opening 23d is located at the second side of the first and second swing levers 5 and 7 opposite to the first side. The spherical portion 22d is accommodated in the joint case 23 from the opening 23d. Thus, for example, even when raindrops or the like enter the wiper device from the upper side of the wiper device (portion of wiper device located at first side) and reach the ball joint 21, entrance of the raindrops into the joint case 23 is prevented or limited.

The first embodiment may be modified as described below.

In the above embodiment, the first swing lever 5, the second swing lever 7, and the drive rod 12 are all arranged at the upper side of the connecting rod 8 (first and second pivot shafts 4 and 6) and connected to the connecting rod 8. However, there is no limit to such a layout.

For example, as shown in FIG. 6, the first swing lever 5 may be arranged at the lower side of the connecting rod 8 and connected to the connecting rod 8. In this case, the second swing lever 7 and the drive rod 12 may also be located at the lower side of the connecting rod 8 and connected to the connecting rod 8.

Further, for example, one of the first swing lever 5, the second swing lever 7, and the drive rod 12 may be arranged at the opposite side of the connecting rod 8 in the vertical direction and connected to the connecting rod 8.

In the above embodiment, the ball pin 22 of the ball joint 21 includes the fixing portion 22b that has the fixing hole 22a through which the connecting rod 8 is extended and fixed. However, the ball pin 22, which includes the spherical portion 22d, may be connected by a different structure to the connecting rod 8.

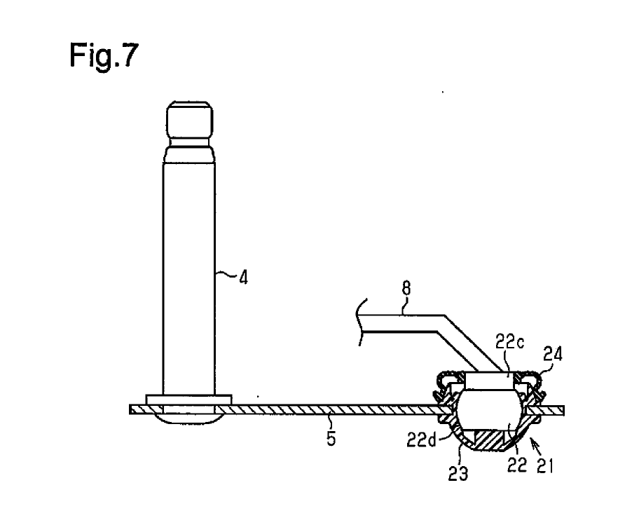

For example, as shown in FIG. 7, the connecting rod 8 may include a bent end fixed (welded or press-fitted) to the shaft portion 22c of the ball pin 22.

In the above embodiment, the first swing lever 5, the second swing lever 7, and the drive rod 12 are each connected to the connecting rod 8 by the same type of ball joint 21 but instead may be connected by a joint of a different structure.

In the above embodiment, the first swing lever 5, the second swing lever 7, and the drive rod 12 are each connected to the connecting rod 8 by the corresponding ball joint 21, and the roll centers Z of the ball joints 21 are located on a straight line. However, the roll centers Z do not have to be located on the straight line.

In the above embodiment, the roll center of each ball joint 21 is located in the thickness range Y of the corresponding one of the first and second swing levers 5 and 7. Instead, the roll center may be located outside the thickness range Y of the corresponding one of the first and second swing levers 5 and 7. For example, in contrast with the above embodiment, the first and second swing levers 5 and 7 may be fixed to the corresponding ball pin 22, and the connecting rod 8 may be fixed to the joint case 23.

In the above embodiment, during operation of the motor 9, that is, during rotation of the crank arm 11, the crank arm 11 overlaps the connecting rod 8 as viewed in the axial direction of the output shaft 10 but instead may be configured not to overlaps the connecting rod 8 when rotated.

In the above embodiment, during operation of the motor 9, the connecting rod 8 passes between the motor 9 and the crank arm 11 (in axial direction of output shaft 10) but instead may be arranged not to pass between the motor 9 and the crank arm 11 (when driven).

In the above embodiment, the connecting rod 8 is a solid (non-hollow) bar formed by a metal bar having a circular cross-section but is not limited to such a shape. For example, the connecting rod 8 may be a solid (non-hollow) bar formed by a metal bar having a substantially circular cross section including a large number of recesses and projections in its circumference. Further, for example, the connecting rod 8 may be formed by a non-solid (hollow) pipe material.

In the above embodiment, the first swing lever 5 and the second swing lever 7 are connected to the connecting rod 8 by the ball joint 21 of which the roll center Z is located in the thickness range Y of the corresponding one of the first and second swing levers 5 and 7. However, as long as one of these sets (e.g., set of first swing lever 5 and connecting rod 8) has the layout described above, the structure of other parts may be changed.

In the above embodiment, the ball joint 21 is arranged so that its roll center Z is located at the center position in the thickness range Y of the corresponding one of the first and second swing levers 5 and 7 but instead may be located at a position separated from the center position of the range Y.

In the above embodiment, one end of the drive rod 12 is connected to the distal end of the crank arm 11 and the other end is connected to the middle portion of the connecting rod 8, which connects the first swing lever 5 and the second swing lever 7. Instead, for example, the other end of the drive rod 12 may be connected to the distal end of the second swing lever 7.

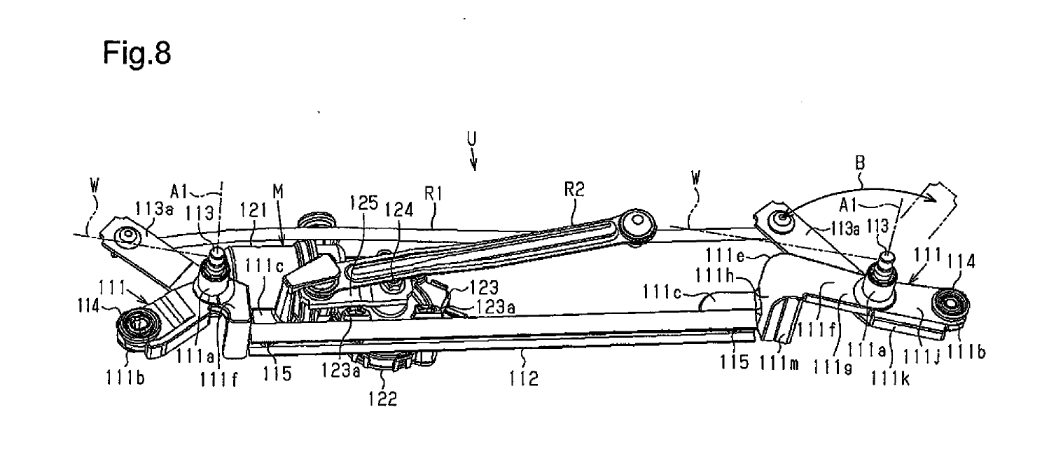

A second embodiment of the wiper device will now be described with reference to FIGS. 8 to 11.

As shown in FIG. 8, a wiper device U includes two pivot holders 111, a connecting frame 112 serving as a connecting frame, a motor M, a connecting rod R1, and a drive rod R2.

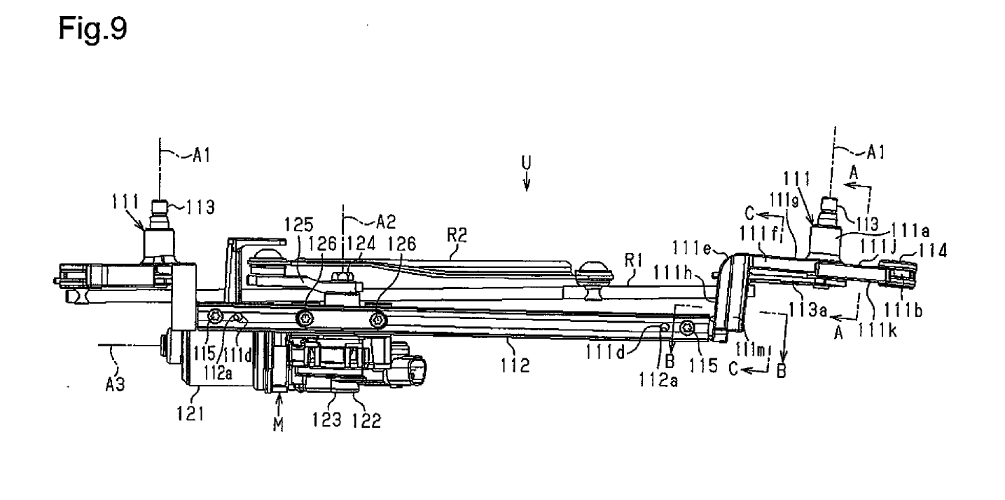

The connecting frame 112 has a C-shaped cross-section that is orthogonal to the longitudinal direction. In detail, the C-shaped cross section of the connecting frame 112 includes two opposing surfaces, which oppose each other in a direction of an axis A1 of a pivot shaft 113, and a back plate surface. The connecting frame 112 includes two ends in the longitudinal direction respectively connected to the pivot holders 111 and a middle portion in the longitudinal direction to which the motor M is fixed. Each pivot holder 111 includes a holder portion 111a, a holder vehicle body fixing portion 111b, and a frame fixing portion 111c. The holder portion 111a is generally tubular and pivotally holds the corresponding pivot shaft 113, which includes an upper end connected to a wiper W. The holder vehicle body fixing portion 111b extends outward in the radial direction from part of the outer circumference of the holder portion 111a. The frame fixing portion 111c, which serves as a connecting frame fixing portion, extends from part of the outer circumference of the holder portion 111a at the opposite side of the holder vehicle body fixing portion 111b. A fixing hole extends through the holder vehicle body fixing portion 111b in the direction of the axis A1 of the pivot shaft 113. A rubber bushing 114 is fitted and fixed to the fixing hole. The holder vehicle body fixing portion 111b is fixed to the vehicle body by a bolt or the like inserted through the rubber bushing 114 and the fixing hole. Each frame fixing portion 111c extends in the longitudinal direction of the connecting frame 112. As shown in FIG. 9, the distal end of each frame fixing portion 111c includes a positioning projection 111d fitted into a positioning hole 112a of the connecting frame 112. In a state in which the positioning projection 111d is fitted into the positioning hole 112a, the frame fixing portion 111c is fixed to the connecting frame 112 by a screw 115 inserted through the back plate surface of the connecting frame 112 and fastened to the basal end of the frame fixing portion 111c. The lower end of each pivot shaft 113 projecting out of the lower end of the holder portion 111a is fixed to a swing lever 113a extending in a direction orthogonal to the axis.

The motor M includes a motor body 121 and a speed reduction unit 122. The motor body 121 is supplied with drive current from an external power supply to rotate a rotor (not shown) inside the motor body 121. The speed reduction unit 122 includes a gear housing 123, which is fixed to the motor body 121, a speed reduction mechanism such as a worm reduction gear (not shown), which reduces the rotation speed of the rotor arranged in the gear housing 123, and an output shaft 124, which is connected to the speed reduction mechanism and projects out of the gear housing 123. The distal end of the output shaft 124 is fixed to the basal end of a flat crank arm 125. The axis A2 of the output shaft 124 (refer to FIG. 9) extends substantially parallel to the axis A1 of each pivot shaft 113. In the present embodiment, the output shaft 124 and the pivot shaft 113 project in the upward direction.

The gear housing 123 includes a side surface in a direction orthogonal to the axis A2 of the output shaft 124 facing a direction orthogonal to the axis A3 of the rotor of the motor body 121. The side surface of the gear housing 123 includes two coupling legs 123a (refer to FIG. 8). The two coupling legs 123a are arranged at positions located at the opposite side of the position where the worm is located in the worm reduction gear accommodated in the gear housing 123.

The gear housing 123 is fixed to the connecting frame 112 by fastening bolts 126 (refer to FIG. 9), which are inserted through the connecting frame 112, and nuts, which are held by the coupling legs 123a.

The connecting rod R1 includes one end connected to the distal end of one of the swing levers 113a (right side in FIG. 8 and located at driver seat side) and another end connected to the other swing lever 113a (left side in FIG. 8 and located at passenger seat side).

The drive rod R2 includes one end connected to a distal end of the crank arm 125 and another end connected to a middle portion of the connecting rod R1 at a location closer to one of the swing levers 113a (swing lever 113a in FIG. 8, namely, the one of the two swing levers 113a farther from motor M). In detail, as shown in FIG. 8, the other end of the drive rod R2 is connected to the middle portion of the connecting rod R1 at a location closer to the right swing lever 113a (i.e., connected to location closer to the one of the two swing levers 113a that is farther from the motor M). Each end of the connecting rod R1 and the drive rod R2 are each driven and connected to another member by a ball joint.

In each pivot holder 111 of the present embodiment, an extension 111e between the holder portion 111a and the frame fixing portion 111c includes a brittle portion 111f. In the present embodiment, one pivot holder 111 (right one in FIG. 8) and the other pivot holder 111 (left one in FIG. 8) slightly differ from each other in size and shape. However, only one of the pivot holders 111 (right one on FIG. 8) will hereafter be described in detail and the other pivot holder 111 (left one in FIG. 8) will not be described. Parts of the pivot holders 111 having the same function will be denoted with the same reference numeral and not be described in detail.

In detail, each pivot holders 111 is an integrally molded product formed from a metal material (e.g., die cast molded product of an aluminum alloy or the like). In the pivot holder 111, the extension 111e located between and connecting the holder portion 111a and the frame fixing portion 111c includes a sideward extending portion 111g, which extends from the holder portion 111a in a direction orthogonal to the axis A1 of the pivot shaft 113, and a vertical extending portion 111h, which extends downward from the distal end of the sideward extending portion 111g and connects to the frame fixing portion 111c. The entire sideward extending portion 111g forms the brittle portion 111f.

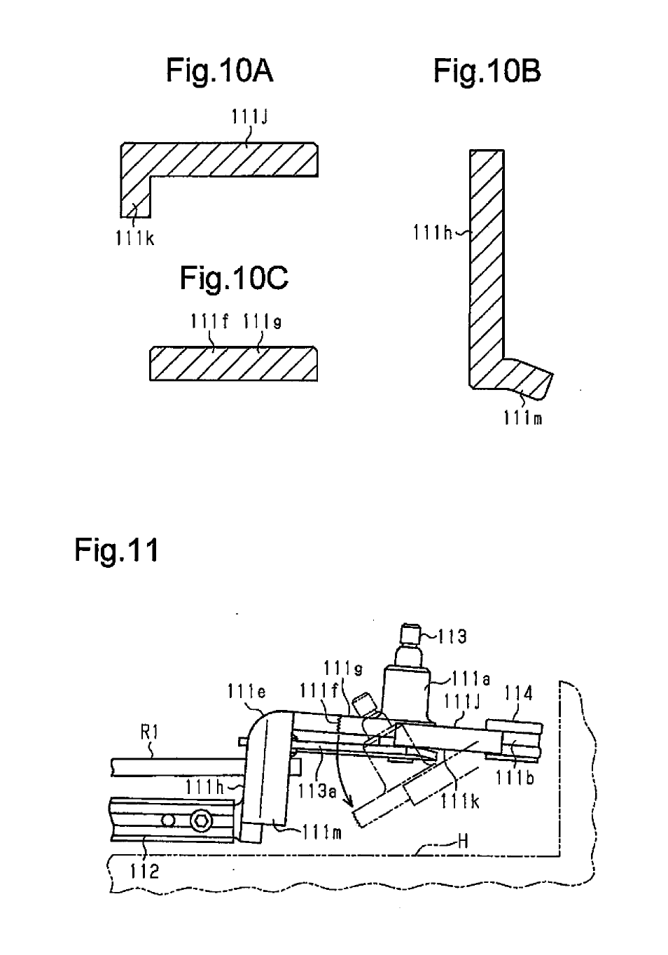

As shown in FIG. 10A, a vehicle body extending portion 111j extends between and connects the holder portion 111a and the holder vehicle body fixing portion 111b. The vehicle body extending portion 111j extends in a direction orthogonal to the axis A1 of the pivot shaft 113 and has a cross section orthogonal to the longitudinal direction that is an L-shaped cross section. In the present embodiment, the vehicle body extending portion 111j includes a rib 111k, which projects from a widthwise end of a plate forming a base in a direction orthogonal to the widthwise direction (downward in present embodiment), so as to have the L-shaped cross-section. Among the two widthwise ends of the vehicle body extending portion 111j, the rib 111k is located on the widthwise end that is farther from a swing range B (refer to FIG. 8) of the swing lever 113a (widthwise end farther from distal end of swing lever 113a).

As shown in FIG. 10B, the vertical extending portion 111h has a cross section orthogonal to the longitudinal direction (vertical direction) that is an L-shaped cross section. In the present embodiment, the vertical extending portion 111h includes a rib 111m, which further projects in the widthwise direction from a widthwise end of a plate forming a base while also projecting in a direction orthogonal to the widthwise direction (basal side of sideward extending portion 111g in present embodiment), so as to have the L-shaped cross-section. Among the two widthwise ends of the vertical extending portion 111h, the rib 111m is located on the widthwise end that is farther from the swing range B (refer to FIG. 8) of the swing lever 113a (widthwise end farther from distal end of swing lever 113a).

As shown in FIG. 10C, the sideward extending portion 111g has a cross section orthogonal to the longitudinal direction that is a rectangular cross section (i.e., shape of plate serving as base continuously maintained) so that the brittle portion 111f is relatively brittle as compared with the vehicle body extending portion 111j and the vertical extending portion 111h that have L-shaped cross-sections. In other words, the vehicle body extending portion 111j and the vertical extending portion 111h that have L-shaped cross-sections are formed as portions that have a relatively higher rigidity than the sideward extending portion 111g, which only includes the plate that serves as a base.

The operation of the wiper device U according to the second embodiment will now be described.

When, for example, a wiper switch located near the driver seat is operated, the motor body 121 is supplied with drive current to rotate and drive the output shaft 124 and the crank arm 125. This transmits power with the connecting rod R1 and the drive rod R2 to the swing levers 113a in order to move the swing levers 113a back and forth and pivot the corresponding pivot shafts 113 back and forth. Thus, the wipers W, which are fixed to the pivot shafts 113, synchronously move back and forth to perform wiping.

Further, as shown in FIG. 11, for example, when the vehicle is traveling, if an object strikes the pivot shaft 113 (basal end of wiper W) and applies an external force in a downwardly axial direction, the brittle portion 111f breaks as the pivot shaft 113 and the holder portion 111a pivot about the holder vehicle body fixing portion 111b and downwardly moves the pivot shaft 113 and the holder portion 111a. This absorbs and reduces the impact applied to the striking object.

The advantages of the second embodiment will now be described.

(12) The extension 111e, which is located between the holder portion 111a and the frame fixing portion 111c, in each pivot holder 111 includes the brittle portion 111f. Thus, for example, when an object strikes and applies an axially downward external force to the pivot shaft 113, even if there is no space below the motor M and the connecting frame 112, the brittle portion 111f can be broken and allow the pivot shaft 113 and the holder portion 111a to move downward. Thus, as shown in FIG. 11, the impact applied to the object can be reduced while reducing the size of the space (providing shallow space) for arrangement of the wiper device.

In particular, the pivot holders 111 each include the vertical extending portion 111h. Thus, when fixing the connecting frame 112 and the frame fixing portion 111c at a location downward (location toward inner side of vehicle) from the pivot shafts 113, the motor M, which is a heavy object fixed to the connecting frame 112, can also be arranged at a downward position. In the prior art, when broken between the holder portion 111a and the holder vehicle body fixing portion 111b, the vertical extending portion 111h would interfere with downward movement of the pivot shaft 113. In the embodiment described above, the brittle portion 111f of the extension 111e between the holder portion 111a and the frame fixing portion 111c breaks. As shown in FIG. 11, this allows the holder portion 111a and the pivot shaft 113 to move downward about the holder vehicle body fixing portion 111b.

(13) The extension 111e includes the sideward extending portion 111g, which extends from the holder portion 111a toward the side opposite to the vehicle body extending portion 111j in a direction orthogonal to the axis A1 of the pivot shaft 113, and the vertical extending portion 111h, which extends downward from the distal end of the sideward extending portion 111g and connects to the frame fixing portion 111c. The brittle portion 111f is included in the sideward extending portion 111g. This, for example, easily obtains a large space below the brittle portion 111f and easily obtains a large downward movement amount for the pivot shaft 113 and the holder portion 111a. When an object strikes and applies an axially downward movement amount to the pivot shaft 113, the brittle portion 111f breaks and the pivot shaft 113 and the holder portion 111a move downward as they pivot about the holder vehicle body fixing portion 111b. In this case, when the brittle portion 111f is located at a position that is as high as possible, the downward movement amount of the pivot shaft 113 and the holder portion 111a can be increased. In the above structure, the brittle portion 111f is included in the sideward extending portion 111g that extends from the holder portion 111a in a direction orthogonal to the axis A1 of the pivot shaft 113. Thus, the brittle portion 111f can be located at a high position in contrast with, for example, when an extension extends diagonally, that is, downwardly straight toward the connecting frame 112 and the middle of the extension includes a brittle portion. This allows the downward movement amount of the pivot shaft 113 and the holder portion 111a to be increased.

(14) The vehicle body extending portion 111j, which is located between the holder portion 111a and the holder vehicle body fixing portion 111b, and the vertical extending portion 111h each have an L-shaped cross section. This increases the rigidity of the vehicle body extending portion 111j and the vertical extending portion 111h. Further, the brittle portion 111f (sideward extending portion 111g) has the form of a simple plate having a rectangular cross section like in the present embodiment. Thus, the brittle portion 111f is relatively brittle compared to the vehicle body extending portion 111j and the vertical extending portion 111h that have L-shaped cross sections. In other words, the vehicle body extending portion 111j and the vertical extending portion 111h that have L-shaped cross-sections are formed as portions that have a relatively higher rigidity than the sideward extending portion 111g.

(15) The swing lever 113a is arranged on the lower end of each pivot shaft 113. The vertical extending portion 111h includes the rib 111m, which extends toward the basal side of the sideward extending portion 111g, to have an L-shaped cross section. The rib 111m is arranged on the one of the two widthwise ends of the vertical extending portion 111h that is farther from the swing range B of the swing lever 113a. This increases the rigidity of the vertical extending portion 111h without the rib 111m narrowing the swing range B of the swing lever 113a.

(16) The lower end of the pivot shaft 113 includes the swing lever 113a. The vehicle body extending portion 111j includes the rib 111k, which extends downward, to have an L-shaped cross section. The rib 111k is arranged on the one of the two widthwise ends of the vehicle body extending portion 111j that is farther from the swing range B of the swing lever 113a. This increases the rigidity of the vehicle body extending portion 111j without the rib 111k narrowing the swing range B of the swing lever 113a.

(17) The rubber bushing 114 is fixed to the holder vehicle body fixing portion 111b. The holder vehicle body fixing portion 111b is fixed to the vehicle body by the rubber bushing 114. This absorbs the vibration transmitted between the wiper device U and the vehicle body. Further, when an object strikes and applies an axially downward external force to the pivot shaft 113 thereby breaking the brittle portion 111f, the rubber bushing 114 elastically deforms and compresses. This allows the pivot shaft 113 and the holder portion 111a to easily pivot about the holder vehicle body fixing portion 111b so that the pivot shaft 113 and the holder portion 111a can downwardly move. Thus, the impact applied to the object can be reduced by the elastic deformation of the rubber bushing 114 that absorbs the impact.

The second embodiment can be modified as described below.

In the above embodiment, the extension 111e between the holder portion 111a and the frame fixing portion 111c includes the sideward extending portion 111g and the vertical extending portion 111h. Further, the brittle portion 111f is arranged on the sideward extending portion 111g. However, the shape of the extension 111e may be changed. In this case, the location of the brittle portion 111f may also be changed to another location on the extension.

In the above embodiment, the vehicle body extending portion 111j and the vertical extending portion 111h each have an L-shaped cross section but may have a cross section shaped differently as long as the rigidity is relatively higher than the brittle portion 111f. Further, as long as the rib 111m does not affect the swing range B of the swing lever 113a, the rib 111m can be arranged on the one of the two widthwise ends of the vertical extending portion 111h that is closer to the swing range B of the swing lever 113a. In the same manner, the rib 111k can be arranged on the one of the two widthwise ends of the vehicle body extending portion 111j that is closer to the swing range B of the swing lever 113a.

In the above embodiment, the holder vehicle body fixing portion 111b is fixed to the vehicle body by the rubber bushing 114. However, the holder vehicle body fixing portion 111b and the vehicle body extending portion 111j may be modified to have a different structure as long as the pivot shaft 113 and the holder portion 111a can be moved downward when the brittle portion 111f breaks.

In the above embodiment, the connecting frame 112 has a C-shaped cross section in a direction orthogonal to the longitudinal direction. Instead, the connecting frame 112 may have, for example, the form of a hollow pipe or any other cross-sectional shape.

1. A wiper device comprising:
a first pivot shaft;
a first swing lever extending from the first pivot shaft in a radial direction of the first pivot shaft and pivoted integrally with the first pivot shaft;
a second pivot shaft;
a second swing lever extending from the second pivot shaft in a radial direction of the second pivot shaft and pivoted integrally with the second pivot shaft;
a connecting rod including a first end connected to a distal end of the first swing lever and a second end connected to a distal end of the second swing lever;
a crank arm extending from an output shaft of a motor in a radial direction of the output shaft and rotated integrally with the output shaft; and
a drive rod including a first end connected to a distal end of the crank arm and a second end connected to a middle portion of the connecting rod.

2. The wiper device according to claim 1, wherein the first swing lever, the second swing lever, and the drive rod are all located on one side of the connecting rod in a vertical direction and connected to the connecting rod.

3. The wiper device according to claim 1, wherein:
the first swing lever, the second swing lever, and the drive rod are each connected to the connecting rod by a ball joint; and
the ball joints have roll centers that are all located on a straight line.

4. The wiper device according to claim 1, wherein
the output shaft of the motor is located at a position closer to the first pivot shaft than the second pivot shaft,
the drive rod is connected to the connecting rod at a position closer to the second swing lever than the first swing lever.

5. The wiper device according to claim 1, wherein the crank arm overlaps the connecting rod as viewed in an axial direction of the output shaft during operation of the motor.

6. The wiper device according to claim 1, wherein the connecting rod passes between the motor and a movement area of the crank arm during operation of the motor.

7. The wiper device according to claim 1, wherein the connecting rod is formed by a solid bar.

8. The wiper device according to claim 1, wherein
at least one of the first swing lever and the second swing lever is connected to the connecting rod by a ball joint, and
the ball joint includes a roll center that is located in a thickness range of the first swing lever and the second swing lever.

9. The wiper device according to claim 1, wherein a connection point of the crank atm and the drive rod alternately moves, as viewed in an axial direction of the output shaft, between a position closer to the output shaft than the connecting rod and a position opposite to the position closer to the output shaft than the connecting rod.

10. A wiper device comprising:
a pivot shaft;
a swing lever extending from the pivot shaft in a direction orthogonal to an axial direction of the pivot shaft;
a connecting rod that transmits drive force to a distal end of the swing lever; and
a ball joint that connects the distal end of the swing lever to the connecting rod,
wherein the ball joint includes a roll center located in a thickness range of the swing lever.

11. The wiper device according to claim 10, wherein the roll center of the ball joint is located at a center position in the thickness range of the swing lever.

12. The wiper device according to claim 10, wherein
the ball joint includes a ball pin that is arranged on the connecting rod and a joint case that is arranged on the swing lever,
the ball pin includes a portion in which the connecting rod is embedded and a spherical portion,
the spherical portion is accommodated in a rollable manner in the joint case,
the pivot shaft extends toward a first side from the swing lever,
the joint case includes a cap and an opening,
the cap is located at the first side of the swing lever and is cap-shaped to cover a portion of the swing lever at the first side, and
the opening is located at a second side of the swing lever opposite to the first side.

13. The wiper device according to claim 10, wherein
the ball joint includes a spherical portion that is arranged on the connecting rod and a joint case that is arranged on the swing lever, and
the spherical portion includes a sphere center that is the roll center.

14. A wiper device comprising:
a motor;
a connecting frame to which the motor is fixed.
a pivot holder including
a holder portion that holds a pivot shaft including an upper end connected to a wiper,
a connecting frame fixing portion extending from the holder portion and fixed to the connecting frame, and
a holder vehicle body fixing portion extending from the holder portion and fixed to the vehicle body;
wherein an extension between the holder portion and the connecting frame fixing portion includes a brittle portion.

15. The wiper device according to claim 14, wherein
the extension includes a sideward extending portion that extends from the holder portion in a direction orthogonal to an axis of the pivot shaft and a vertical extending portion that extends downward from a distal end of the sideward extending portion and connects to the connecting frame fixing portion, and
the brittle portion is located on the sideward extending portion.

16. The wiper device according to claim 15, wherein
a vehicle body extending portion is located between the holder portion and the holder vehicle body fixing portion, and
the vehicle body extending portion and the vertical extending portion each have an L-shaped cross section.

17. The wiper device according to claim 15, wherein
a swing lever that is rotatable integrally with the pivot shaft and allows for input and output of power is arranged on a lower end of the pivot shaft,
the vertical extending portion includes a rib extending toward a basal side of the sideward extending portion and thereby has an L-shaped cross section, and
the rib is arranged on one of two widthwise ends of the vertical extending portion that is farther from a swing range of the swing lever.

18. The wiper device according to claim 14, wherein
a swing lever that is rotatable integrally with the pivot shaft and allows for input and output of power is arranged on a lower end of the pivot shaft,
a vehicle body extending portion is located between the holder portion and the holder vehicle body fixing portion,
the vehicle body extending portion includes a rib extending downward and thereby has an L-shaped cross section, and
the rib is arranged on the one of two widthwise ends that is farther from a swing range of the swing lever.

19. The wiper device according to claim 14, wherein
a rubber bushing is fixed to the holder vehicle body fixing portion, and
the holder vehicle body fixing portion is fixed to a vehicle body by the rubber bushing.
